(19) United States
(12) Patent Application Publication
(10) Pub. No.: US 2022/0305938 A1
(43) Pub. Date: Sep. 29, 2022

(54) BATTERY PALLET RACKING SYSTEM AND METHOD FOR CHARGING BATTERIES IN A BATTERY PALLET RACKING SYSTEM

(71) Applicant: Hyliion Inc., Cedar Park, TX (US)

(72) Inventor: Thomas Healy, Austin, TX (US)

(21) Appl. No.: 17/705,162

(22) Filed: Mar. 25, 2022

Related U.S. Application Data
(60) Provisional application No. 63/166,827, filed on Mar. 26, 2021.

(51) Int. Cl. B60L 53/62; H02J 7/00; B60S 5/06; B60L 58/12; B60L 53/30; B60L 53/16; B60L 53/67

(52) U.S. Cl. CPC B60L 53/62; H02J 7/0013; H02J 7/00036; H02J 7/0048; H02J 7/00712; B60S 5/06; B60L 58/12; B60L 53/305; B60L 53/16; B60L 53/67

(57) ABSTRACT

A battery pallet racking system stores a plurality of battery pallets for use by a plurality of vehicles and manages charging the plurality of battery pallets based on the needs of the plurality of vehicles. The system communicates with a vehicle to determine a state of charge needed by the vehicle, selects a battery pallet to provide the state of charge, and charges the selected battery pallet to the state of charge. Battery pallets may be charged serially, collectively in parallel or individually to meet states of charge for the plurality of vehicles.

### BACKGROUND

### Priority Claim

The present application claims priority to U.S. Provisional Patent Application Ser. No. 63/166827, filed Mar. 26, 2021, which is incorporated by reference herein in its entirety.

### Field of the Disclosure

This disclosure relates generally to electric vehicles and battery systems and, more particularly, to battery racking systems and systems for charging batteries in a battery racking system.

### Description of the Related Art

Electric vehicles (EVs) rely on multiple batteries to supply electric power to motors. Charging the batteries involves the driver locating a charging station, plugging the EV into the charging station and waiting for the batteries to charge to a State of Charge (SoC) to get them to their destination.

### SUMMARY

Embodiments disclosed herein may be directed to interchangeable battery pallets for installation inside a cargo area of a cargo-capable vehicle, such as a box truck, a trailer of a truck/trailer combination, a bus such as a passenger bus with a cargo area, or any other cargo-carrying vehicle that may be accessible by a forklift, pallet jack as known in the art, or other cargo-moving device, and to battery pallet racking systems and methods for charging battery pallets using a battery pallet racking system.

Embodiments of a pallet racking system can manage the recharging of multiple battery pallets to optimize the recharging of each battery pallet but minimize the amount of time that a trailer sits at the warehouse. Optimizing the recharging of a battery pallet may involve slowly recharging the battery at a constant rate and/or voltage or recharging the battery at a voltage or current based on the State of Charge (SOC) of the battery. Optimizing the recharging of a battery pallet may involve recharging the battery based on the electrical constraints of the warehouse or other equipment operating in the warehouse.

Embodiments may be directed to a battery pallet racking system for use in a facility with a set of docks configured for parking a plurality of vehicles, each vehicle having a battery pallet installed. The battery pallet racking system may comprise a battery pallet charging rack for storing a plurality of battery pallets, at least one charger connected to the plurality of battery pallets; and a management console storing a set of instructions. When executed by a processor, the set of instructions cause the battery pallet racking system to communicate with each battery pallet of the plurality of battery pallets stored on the pallet charging rack to determine a state of charge for each battery pallet of the plurality of battery pallets; communicate with a vehicle to determine a battery pallet with a state of charge below a minimum state of charge is installed in the vehicle; and communicate with the at least one charger to provide electric power to at least one battery pallet of the plurality of battery pallets stored on the battery pallet racking system to charge the at least one battery pallet to a target state of charge. When the vehicle is parked at a dock at the facility, the set of instructions cause the battery pallet racking system to communicate a signal to remove the battery pallet with the state of charge below the minimum state of charge from the vehicle and communicate a signal to install the battery pallet with the target state of charge into the vehicle.

In some embodiments, the battery pallet charging rack stores a set of battery pallets of the plurality of battery pallets in a row and the at least one charger comprises a charger coupled to a single charging connection corresponding to a first battery pallet of the set of battery pallets, wherein each battery pallet in the set of battery pallets comprises a first charging connection on a first side of the battery pallet for connecting to a battery pallet adjacent to the first side and a second charging connection on a second side of the battery pallet opposite the first side for connecting to a battery pallet adjacent to the second side. The set of instructions, when executed by the processor, cause the battery pallet racking system to communicate with the charger to supply electric power to the first battery, wherein the set of battery pallets are charged in series to the target state of charge; and select a battery pallet from the set of battery pallets for installing in the vehicle.

In some embodiments, the at least one charger comprises a plurality of chargers, wherein each charger of the plurality of chargers is coupled to a charging connection of a battery pallet of the plurality of battery pallets, wherein the set of instructions, when executed by the processor, cause the battery pallet racking system to: select a battery pallet of the plurality of battery pallets for charging to the target state of charge; communicate with a charger connected to the selected battery pallet to charge the selected battery pallet to the target state of charge; and communicate a signal to install the selected battery pallet with the target state of charge in the vehicle.

In some embodiments, to determine a battery pallet with a state of charge below a minimum state of charge is installed in a vehicle, the set of instructions, when executed by the processor, cause the battery pallet racking system to communicate with the vehicle to determine a route over which the vehicle will travel and calculate the minimum state of charge based on the route. In some embodiments, to determine a battery pallet with a state of charge below a minimum state of charge is installed in a vehicle, the set of instructions, when executed by the processor, cause the battery pallet racking system to communicate with the vehicle to determine a vehicle weight and calculate the minimum state of charge based on the vehicle weight.

In some embodiments, the set of instructions, when executed by the processor, cause the battery pallet racking system to: determine a location on the vehicle of the battery pallet with a state of charge below the minimum state of charge; communicate a signal to remove the battery pallet with a state of charge below the minimum state of charge from the location on the vehicle; and communicate a signal to install the battery pallet with the target state of charge in the location on the vehicle.

In some embodiments, the set of instructions, when executed by the processor, cause the battery pallet racking system to select a battery pallet with a state of charge closest to the target state of charge and communicate with a charger associated with the selected battery pallet to charge the selected battery pallet to the target state of charge.

Embodiments may be directed to a method of operating a battery pallet racking system in a facility, comprising storing a plurality of battery pallets; determining a state of charge of each battery pallet of the plurality of battery pallets; communicating with a vehicle to determine a state of charge of a battery pallet in the vehicle; determining a battery pallet with a state of charge below a minimum state of charge is installed in the vehicle; selecting a battery pallet from the plurality of battery pallets for installing in the vehicle and communicating with a charger connected to the selected battery pallet to charge the selected battery pallet to a target state of charge. When the vehicle is at the facility the method includes communicating a signal to remove the battery pallet with the state of charge below the minimum state of charge from the vehicle and communicating a signal to install the selected battery pallet with the target state of charge into the vehicle.

In some embodiments, the method includes connecting a charger to a charging connection on a first side of a first battery pallet, connecting a charging connection on a second side of the first battery pallet to a charging connection on a first side of a second battery pallet, and communicating a signal to the charger to provide electric power to the first battery pallet, wherein the first battery pallet and the second battery pallet are charged in series, wherein selecting a battery pallet from the plurality of battery pallets for installing in the vehicle comprises selecting one of the first battery pallet or the second battery pallet.

In some embodiments, the method includes connecting a first charger to a charging connection on a first battery pallet, connecting a second charger to a charging connection on a second battery pallet, selecting a battery pallet of the plurality of battery pallets for charging to the target state of charge, and communicating with the first charger to charge the first battery pallet to the target state of charge, wherein selecting a battery pallet from the plurality of battery pallets for installing in the vehicle comprises selecting the first battery pallet.

In some embodiments, determining a battery pallet with a state of charge below a minimum state of charge is installed in the vehicle comprises determining the vehicle is traveling on a route to the facility, communicating with the vehicle to determine a present state of charge of the battery pallet installed on the vehicle, calculating an end state of charge of the battery pallet installed on the vehicle based on the route, and determining the end state of charge will be below the minimum state of charge.

In some embodiments, determining a battery pallet with a state of charge below a minimum state of charge is installed in the vehicle comprises communicating with the vehicle to determine a vehicle weight, calculating an end state of charge of the battery pallet installed on the vehicle based on the vehicle weight, and determining the end state of charge will be below the minimum state of charge.

In some embodiments, the method includes determining a location on the vehicle of the battery pallet with a state of charge below the minimum state of charge, communicating a signal to remove the battery pallet with a state of charge below the minimum state of charge from the location on the vehicle, and communicating a signal to install the battery pallet with the target state of charge in the location on the vehicle.

In some embodiments, selecting a battery pallet from the plurality of battery pallets for installing in the vehicle comprises selecting a battery pallet with a state of charge closest to the target state of charge.

Embodiments may be directed to a facility comprising a plurality of docks configured for parking a plurality of vehicles; a battery pallet racking system comprising a battery pallet charging rack for storing a plurality of battery pallets, at least one charger connected to the plurality of battery pallets, and a management console storing a set of instructions. When executed by a processor, the set of instructions cause the battery pallet racking system to communicate with each battery pallet of the plurality of battery pallets stored on the pallet charging rack to determine a state of charge for each battery pallet of the plurality of battery pallets, communicate with a set of vehicles to determine a battery pallet with a state of charge below a minimum state of charge is installed in a vehicle of the set of vehicles, and communicate with the at least one charger to provide electric power to at least one battery pallet of the plurality of battery pallets stored on the battery pallet racking system to charge the at least one battery pallet to a target state of charge. When the vehicle is parked at a dock at the facility, the set of instructions cause the battery pallet racking system to communicate a signal to remove the battery pallet with the state of charge below the minimum state of charge from the vehicle and communicate a signal to install the battery pallet with the target state of charge into the vehicle.

In some embodiments, the battery pallet charging rack stores a set of battery pallets of the plurality of battery pallets in a row and the at least one charger comprises a charger coupled to a single charging connection corresponding to a first battery pallet of the set of battery pallets, wherein each battery pallet in the set of battery pallets comprises a first charging connection on a first side of the battery pallet for connecting to a battery pallet adjacent to the first side and a second charging connection on a second side of the battery pallet opposite the first side for connecting to a battery pallet adjacent to the second side. The set of instructions, when executed by the processor, cause the battery pallet racking system to communicate with the charger to supply electric power to the first battery, wherein the set of battery pallets are charged in series to the target state of charge and select a battery pallet from the set of battery pallets for installing in the vehicle.

In some embodiments, the at least one charger comprises a plurality of chargers, wherein each charger of the plurality of chargers is coupled to a charging connection of a battery pallet of the set of battery pallets. The set of instructions, when executed by the processor, cause the battery pallet racking system to select a battery pallet of the set of battery pallets for charging to the target state of charge, communicate with a charger connected to the selected battery pallet to charge the selected battery pallet to the target state of charge and communicate a signal to install the selected battery pallet with the target state of charge in the vehicle.

In some embodiments, to determine a battery pallet with a state of charge below a minimum state of charge is installed in a vehicle, the set of instructions, when executed by the processor, cause the battery pallet racking system to communicate with the vehicle to determine a route over which the vehicle will travel and calculate the minimum state of charge based on the route. In some embodiments, to determine a battery pallet with a state of charge below a minimum state of charge is installed in a vehicle, the set of instructions, when executed by the processor, cause the battery pallet racking system to communicate with the vehicle to determine a vehicle weight and calculate the minimum state of charge based on the vehicle weight.

In some embodiments, to communicate a signal to install the battery pallet with the target state of charge into the vehicle, the set of instructions, when executed by the processor, cause the battery pallet racking system to determine a location on the vehicle of the battery pallet with a state of charge below the minimum state of charge, communicate a signal to remove the battery pallet with a state of charge below the minimum state of charge from the location on the vehicle, and communicate a signal to install the battery pallet with the target state of charge in the location on the vehicle.

### BRIEF DESCRIPTION OF THE DRAWINGS

For a more complete understanding of the invention and its features and advantages, reference is now made to the following description, taken in conjunction with the accompanying drawings, in which:

FIGS. 1-2 and 3A-3B depict cutaway side views of example truck-trailer combinations with selected elements of an embodiment of a battery pallet;

FIG. 4 is a top view of an example facility with one embodiment of a pallet racking system installed therein;

FIG. 5 is a perspective view of one embodiment of a battery pallet;

FIG. 6 is a block diagram of one embodiment of a battery pallet racking system; and

FIG. 7 is a flowgraph, illustrating a method for managing charging in a battery pallet racking system.

### DESCRIPTION OF PARTICULAR EMBODIMENT(S)

In the following description, details are set forth by way of example to facilitate discussion of the disclosed subject matter. It should be apparent to a person of ordinary skill in the field, however, that the disclosed embodiments are exemplary and not exhaustive of all possible embodiments.

As used herein, a hyphenated form of a reference numeral refers to a specific instance of an element and the un-hyphenated form of the reference numeral refers to the collective or generic element. Thus, for example, battery pallet “110-1” refers to an instance of a battery pallet, which may be referred to collectively as battery pallets “110” and any one of which may be referred to generically as battery pallet “110.”

For the purposes of this disclosure, a battery pallet may refer to a collection of batteries assembled into a single unit or one or more electrochemical cells arranged within a battery pallet enclosure or housing. A battery pallet may provide electrical power to components and subsystems of a vehicle. For example, one or more battery pallets may provide electrical power to an electric motor in a drivetrain to propel the vehicle on a route, may provide electrical power to an air condition system for cooling a compartment in the vehicle, and may provide electrical energy for a navigation system.

EV trucks have a limited range is very limited due in part to limitations of the size of the battery pallet that can be installed on the truck frame. Furthermore, the time to recharge a battery pallet is significantly longer (e.g., hours) than the time presently needed to refill a traditional diesel truck (e.g., minutes). Also, the infrastructure for traditional diesel trucks is significantly more developed than any electric recharging infrastructure, particularly when recharging a vehicle can take hours.

Embodiments disclosed herein include a battery pallet, a trailer for coupling to an EV truck, and a battery pallet racking system.

### Battery Pallet Designed for Installing Inside a Trailer

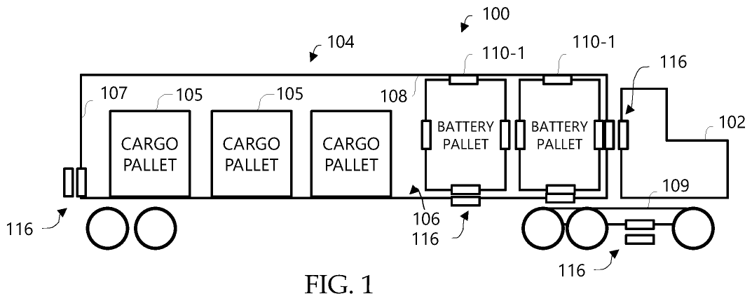

Referring to FIGS. 1-2 and 3A-3B, truck-trailer combination 100 includes truck 102 and trailer 104 for transporting cargo pallets 105, and one or more battery pallets 110 for supplying electric power to one or more of truck 102 and trailer 104. Although features and advantages of interchangeable battery pallets are disclosed herein in terms of use in a trailer, battery pallets 110 are interchangeable within any cargo-capable vehicle, such as a box truck, a trailer of a truck/trailer combination, a bus such as a passenger bus with a cargo area, or any other cargo-carrying vehicle. A truck 102 or trailer 104 may have a single battery pallet 110 or a plurality of battery pallets 110 installed.

Truck 102 may be an EV truck in which all motive power is supplied by electric motors powered by battery pallet 110. Truck 102 may be configured with a battery pallet 110 for driving truck 102 when trailer 104 is not attached. Truck 102 may include an onboard information handling system capable of monitoring a set of truck parameters for components and subsystems on truck 102 and communicating the set of truck parameters over a network, discussed in greater detail below.

Trailer 104 comprises floor 106, walls 107 and roof 108 defining a cargo area of trailer 104 for accommodating cargo pallets 105. In some embodiments (not shown) trailer 104 is a refrigeration trailer with an air conditioning system for maintaining a temperature within trailer 104. When connected to truck 102, trailer 104 may communicate a set of trailer parameters to truck 102. Trailer 104 may be connected to truck 102 with a wired connection or wirelessly. Electric power may be transferred between trailer 104 and truck 102 via one or more connections 116, discussed in greater detail below.

Embodiments of a battery pallet 110 may be configured for installing inside the cargo area of trailer 104. The basic design of the cargo area of trailers 104 allows forklifts 120, pallet jacks, or other cargo-moving devices to quickly and easily move cargo pallets 105 in and out of the trailer 104. Embodiments described herein may utilize the design of the cargo area to quickly and easily remove and install battery pallets 110.

Installing a battery pallet 110 inside trailer 104 or other cargo-carrying vehicle such as a box truck, a bus with a cargo area, or other cargo-capable vehicle allows a forklift 120 to install and remove battery pallets 110 from trailer 104 without leaving a warehouse area.

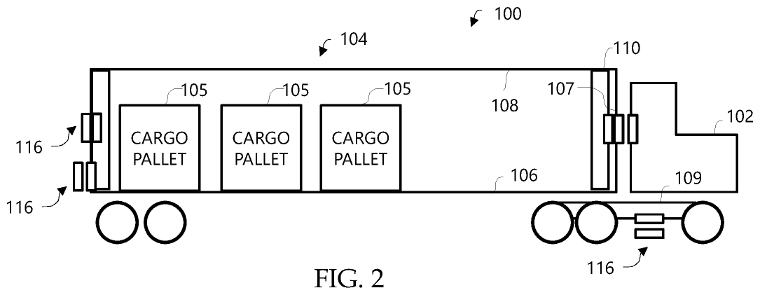

Referring to FIGS. 1-2, battery pallet 110 may be installed in a generally vertical orientation, wherein battery pallet 110 occupies little floor space inside trailer 104. One or more battery pallets 110 may be installed in trailer 104 before any cargo pallets 105 are installed, or one or more battery pallets 110 may be installed in trailer 104 after all cargo pallets 105 are installed. Battery pallets 110 oriented vertically may be positioned against side wall 107-1 or front wall 107-2. For example, trailer 104 may be configured with a first battery pallet 110 positioned against side wall 107-1 such that a smaller cargo pallet 105 can be loaded in trailer 104 and positioned adjacent to battery pallet 110 or may be positioned against front wall 107-2 to allow two cargo pallets 105 to be loaded in a side-by-side configuration (not shown).

Connections 116 between battery pallet 110 and trailer 104 may comprise wireless or wired connections. In some embodiments, connections 116 between battery pallet 110 and trailer 104 may be elevated above floor 106 to prevent damage by forklift 120 or cargo pallets 105.

Battery pallets 110 may be installed in trailer 104 using a combination of the configurations depicted in FIGS. 1-2. For example, a warehouse may want to ship four cargo pallets 105 to multiple destinations but trailer 104 may not be able to hold four cargo pallets 105 and two battery pallets 110. In this scenario, trailer 104 may be configured with a single battery pallet 110 positioned against front wall 107-2 such that four cargo pallets 105 can be loaded in trailer 104. When trailer 104 reaches an intermediate station, the most rearward cargo pallet 105 may be removed and a second battery pallet 110 may be installed to finish the delivery of the remaining three cargo pallets 105.

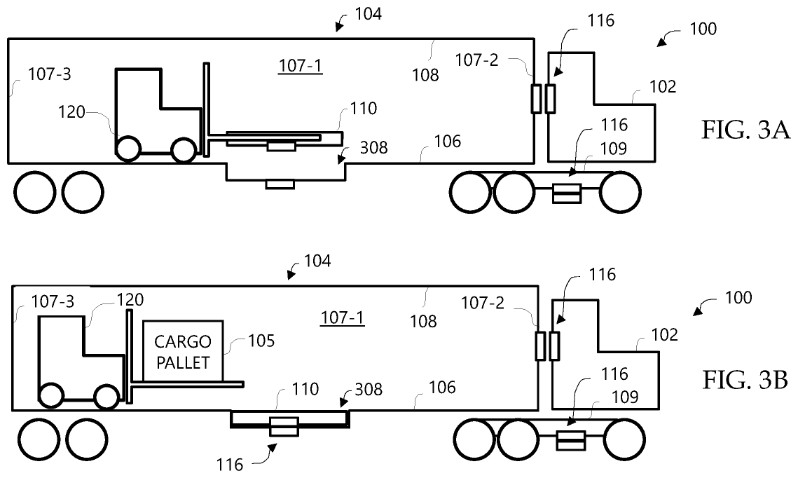

Referring to FIGS. 3A and 3B, in some embodiments, floor 106 of trailer 104 may be configured with a recessed area 308 for receiving battery pallets 110. Forklift 120 used to install and remove battery pallets 110 may be the same forklift 120 used to install and remove cargo pallets 105, minimizing the number of forklifts 120 needed by a warehouse to conduct shipping operations and manage battery pallets 110 in trailers 104.

Referring to one or more of FIGS. 1-2 and 3A-3B, embodiments of truck-trailer combination 100 may include charging connections 116 for charging battery pallets 110 installed in trailer 104. Charging connections 116 near the rear deck of trailer 104 allows charging of battery pallets 110 when trailer 104 is backed up to a dock. Charging connections 116 under recessed area 308 allow charging of battery pallets 110 when trailer 104 is positioned over a recharging zone. In some embodiments, when truck 102 is coupled to trailer 104 and positioned over a recharging zone, battery pallet 110 inside truck 102 may be charged and a charging connection 116 between truck 102 and trailer 104 allows battery pallets 110 to also charge.

### Warehouse Design and Operation

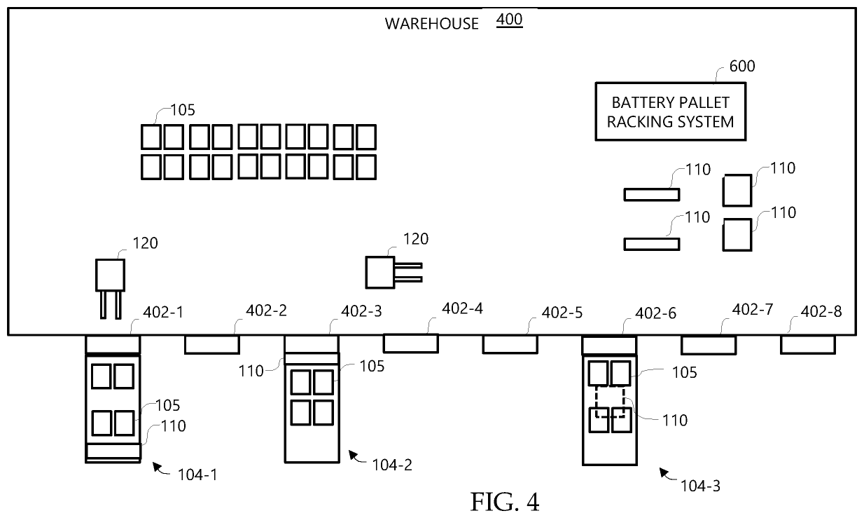

FIG. 4 depicts a schematic diagram of a warehouse environment. As depicted in FIG. 4, warehouse 400 comprises a plurality of docks 402, each dock 402 configured for accommodating a trailer 104 to allow loading and unloading of cargo pallets 105 by forklift 120. Cargo pallets 105 may have the same basic footprint but vary in weight and may be full pallets or half pallets. A first trailer 104-1 may be parked at dock 402-1, a second trailer may be parked at dock 402-d a third trailer 104-3 may be parked at a third dock 402-6. Warehouse 400 may also comprise a plurality of battery pallets 110 for use in trailers 104 and a battery pallet racking system 600 for ensuring one or more battery pallets are available for trailers 104, discussed in greater detail below.

Warehouses 400 are not set up to have forklifts 120 outside, and there's a ground difference because of the truck backups and the loading docks. Forklifts 120 may be configured for use only inside warehouse 400, such that driving forklifts 120 outside of warehouse 400 is inconvenient and/or discouraged. Embodiments allow warehouse 400 to utilize forklifts 120, pallet jacks, or other cargo-moving devices to easily and efficiently install and remove battery pallets 110 from trailers 104 without leaving the warehouse area. Since the battery pallet 110 would technically be accessed from inside the trailer 104, forklifts 120 can easily access a battery pallet 110 and bring it into the warehouse versus having to drive outside warehouse to remove or install battery pallets 110.

### Battery Pallets

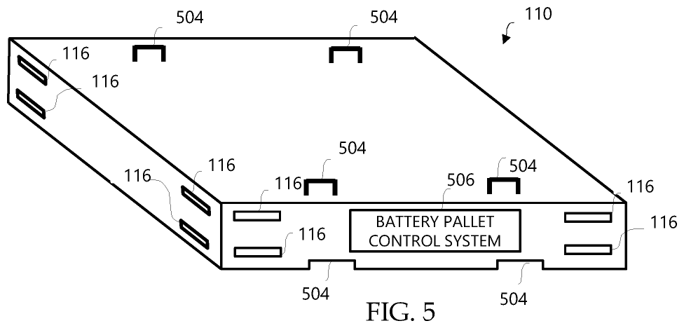

FIG. 5 depicts a perspective view of one embodiment of a battery pallet 110. As depicted in FIG. 5, battery pallet 110 may comprise one or more charging connections 116, forklift coupling features 504 and battery pallet control system 506. Battery pallets 110 may be interchangeable with other like-sized battery pallets 110 to enable trucks 102 to easily swap battery pallets 110. In some trucks 102 or trailers 104, multiple battery pallets 110 may be installed. In some embodiments, a first battery pallet 110 may operate to start an engine and operate accessories, wherein a generator coupled to the engine charges the battery pallet 110. In some embodiments, the battery pallet 110 may also be used to drive an e-axle and/or drive equipment such as refrigeration equipment in a cargo area.

Each side of battery pallet 110 may have one or more charging connections 116. The position and orientation of each charging connection 116 may be configured for receiving a charge from a charger (which may receive electrical power from an electrical power source) and may also be configured for receiving an electrical charge or supplying an electrical charge to a charging connection 116 of an adjacent battery pallet 110.

Charging connections 116 are configured to allow charging of battery pallet 110 when positioned on a battery pallet charging rack or when installed in trailer 104. Battery pallet 110 may be charged by supplying electric power via charging connections 116 when the battery pallet 110 is positioned on a battery pallet charging rack, such as by supplying electric power from a power grid. Battery pallet 110 may also be charged by supplying electric power via charging connections 116 when the battery pallet 110 is installed in trailer 104, such as by operating a motor/generator as a generator.

Battery pallet 110 may have a substantially flat profile or thin profile that allows them to be easily maneuvered by a forklift, a pallet jack as known in the art, or other cargo-carrying device. In some embodiments, the thickness of the battery pallet 110 may comprise a thickness that is not greater than 5%, 10%, 15%, 20%, or even 25% of a length and/or a width of the battery pallet 110. Further, in some embodiments, the length and width of the battery pallet 110 may form a substantially square or substantially rectangular profile of the battery pallet 110. Accordingly, in some embodiments, the length of the battery pallet may be not greater than 25%, not greater than 20%, not greater than 15%, not greater than 10%, or not greater than 5% of the width of the battery pallet 110. In some embodiments, the length of the battery pallet 110 may comprise substantially the same dimension as the width of the battery pallet 110. For example, embodiments of the battery pallet 110 may comprise a 1.22 meter (48 inch) length, a 1.22 meter (48 inch) width, and a thickness between 100 to 200 millimeters (about 4 to 8 inches). Embodiments of battery pallet 110 may be configured for receiving forks of forklifts 120. In some embodiments, battery pallet 110 may be configured with forklift coupling features 504 near the base of battery pallet 110 for receiving the forks of forklifts 120 may be cutouts or openings. In some embodiments, battery pallet 110 may be configured for installation inside recessed area 408 of trailer 404, wherein forklift coupling features 504 may be located near the top of battery pallet 110 for receiving the forks of forklifts 120 may be rings or loops, and may be hinged or otherwise configured for recessed positioning when not used to move battery pallet 110 and extend for coupling to forklift 120.

Battery pallet control system 506 may include components such as a processor, a memory and communication components for monitoring the operation of battery pallet 110 and communicating a set of battery pallet parameters.

Embodiments allow warehouse 400 to utilize forklifts 120 to install and remove battery pallets 110 from trailer 104 without leaving the warehouse area and also move battery pallets 110 to and from battery pallet racking system 600.

### Charging Battery Pallets in a Battery Pallet Racking System

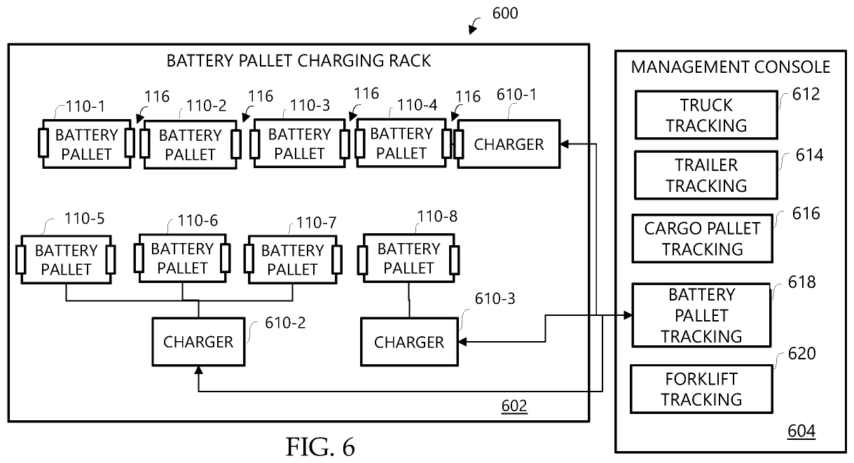

Referring to FIG. 6, embodiments of battery pallet racking system 600 store a plurality of battery pallets 110 in sets of battery pallets 110. Battery pallet racking system 600 comprises battery pallet charging rack 602 configured to store sets of battery pallets 110 in one or more columns, one or more rows, or a combination thereof. Battery pallets 110 in a single row or column of battery pallets 110 may be charged serially, collectively in parallel, or independently. Charging connections 116 on each battery pallet 110 allows multiple battery pallets 110 to be placed next to each other for charging without any cable connections between them. Battery pallet charging rack 602 may be configured to ensure charging connections 116 of adjacent battery pallets 110 align for serial charging of a set of battery pallets 110.

Referring to FIGS. 5 and 6, battery pallets 110 may be configured for positioning in a horizontal orientation in which a width is greater than a height and positioned side-by-side with adjacent battery pallets 110. In other embodiments (not shown), battery pallets 110 may be configured for positioning in a vertical orientation in which a height is greater than a width height and positioned side-by-side with adjacent battery pallets 110. Other orientations are possible to allow for reduced space within a warehouse, accommodate battery cell design, battery pallet cooling, easier transportation of a battery pallet 110 to a truck 102 or trailer 104, and other factors.

Wireless charging connections 116 may connect each battery pallet 110 to adjacent battery pallets 110 and allow for energy transfer. Wireless connections 116 make it very easy for a forklift driver to put battery pallets 110 in battery pallet charging rack 602 and remove battery pallets 110 from battery pallet charging rack 602. Embodiments of a battery pallet racking system 600 may manage the charging of multiple battery pallets 110 to meet the demands of a warehouse 400 and optimize the charging of each battery pallet 110. Furthermore, a plurality of battery pallets 110 managed by battery pallet racking system 600 may buffer power demands of warehouse 400.

Referring to FIG. 6, battery pallet racking system 600 may comprise battery pallet charging rack 602 and management console 604 storing instructions executable by a processor for managing the charging of a plurality of battery pallets 110 and ensuring the shipping needs of warehouse 400 are met by ensuring one or more battery pallets 105 are available for each trailer 104 associated with warehouse 400.

Battery pallet charging rack 602 may hold a plurality of battery pallets 110 and charge each battery pallet 110. In some embodiments, battery pallet charging rack 602 may be configured to charge multiple battery pallets 110 in series, in parallel or independently.

As depicted in FIG. 6, a first row may store a first plurality of battery pallets 110 (i.e., 110-1, 110-2, 110-3 and 110-4) and have charger 610-1 coupled to a single charging connection 116 positioned near a first battery pallet 110-4 for serial charging of battery pallets 110-1 through 110-3. Charging connections on adjacent battery pallets 110 allow the powers supplied to charging connection 116 to charge all battery pallets 110 in the same row at the same rate. This configuration may allow battery pallet racking system 600 to efficiently charge a plurality of battery pallets 110, and the plurality of connected battery pallets 110 may buffer the electric charging to prevent surges in electric power from damaging any one battery pallet 110. This configuration may also be advantageous for charging a plurality of battery pallets 110 to the same SOC.

As depicted in FIG. 6, a second row may store a second plurality of battery pallets 110 and have a second charger 610-2 coupled to multiple battery pallets 110 (i.e., battery pallets 110-5, 110-6 and 110-7) in parallel. In some embodiments, charging of battery pallets 110 in parallel may allow for insertion and removal of individual battery pallets 110. In some embodiments, independent charging of each battery pallet 110 may reduce the amount of time needed for battery pallet racking system 600 to provide a battery pallet 110 to trailer 104. In some embodiments, a charger 610-3 may be coupled to a single battery pallet 110.

Battery pallet racking system 600 may include truck tracking system 612 for tracking information about trucks 102 in relation to warehouse 400. Truck tracking system 612 may communicate with a plurality of trucks 102 to get information about each truck 102 and/or each battery pallet 110 carried by the truck 102. Communication may be over a cellular network, a satellite network or some other network that allows for real-time or near real-time communications. The information may include information about truck 102, such as a location, speed, truck weight and battery charge of any battery pallets 109 installed on truck 102.

Battery pallet racking system 600 may include trailer tracking system 614 for tracking information about trailers 104 in relation to warehouse 400. Trailer tracking system 614 may communicate with a plurality of trailers 104 to get information about each trailer 104. Communication may be over a cellular network, a satellite network or some other network that allows for real-time or near real-time communications. The information may include trailer weight, trailer information such as if refrigeration is needed to cool any cargo, and trailer information indicating a location of one or more battery pallets 110 installed in trailer 104.

Battery pallet racking system 600 may include cargo pallet tracking system 616 for tracking information about cargo pallets 105 in relation to warehouse 400. The information may include cargo pallet information about one or more cargo pallets 105 stored in warehouse and transported in trailers 104 inbound to warehouse 400. Battery pallet racking system 600 may communicate with a warehouse server to get information about a plurality of cargo pallets 105 originating from warehouse 400, passing through warehouse 400 to a final destination or ending at warehouse 400. The information may include a size, weight or other cargo pallet parameters. The information may also include other information such as an estimated arrival time of a cargo pallet 105, a deadline for a cargo pallet 105 to leave warehouse 400 or a deadline for a cargo pallet 105 to reach a final destination. Cargo pallet information may include weight and dimensions of each cargo pallet 105 and a position of each cargo pallet 105 in warehouse 400 and in each trailer 104. Cargo pallet information may be communicated with truck information or trailer information.

Battery pallet racking system 600 may include battery pallet tracking system 618 for tracking information about battery pallets 110 in relation to warehouse 400. The information may include battery pallet information about one or more battery pallets 110 on battery pallet charging rack 602 or installed in trailers 104. Battery pallet racking system 600 may communicate with each battery pallet control system 506 on each battery pallet 110 to determine a set of battery pallet parameters for the battery pallet 110. The set of battery pallet parameters may include a state of charge (SOC), temperature, a number of charging cycles and other information for the battery pallet 110.

In some embodiments, battery pallet racking system 600 may include forklift tracking system 620 for communicating with one or more forklifts 120 to get information about each forklift 120. Forklift tracking system 620 may communicate with a forklift 120 to get information a cargo pallet 105 or a battery pallet 110 being transported by forklift 120. In some embodiments, forklift 120 may have charging connections 116 such that, when battery pallet 110 is transported by forklift 120, battery pallet 110 may be used to power forklift 120 and/or charge internal batteries in forklift 120. When a battery pallet 110 is removed from trailer 104, forklift 120 may communicate with battery pallet 110 to get battery pallet parameters. Forklift 120 may communicate with battery pallet racking system 600 to send a position of forklift 120 inside warehouse 400 and a set of battery pallet parameters. Battery pallet racking system 600 may communicate to forklift 120 a position in battery pallet charging rack 602 for the battery pallet 110. When a battery pallet 110 is to be installed in a trailer 104, battery pallet racking system 600 may communicate a position of a battery pallet 110 on battery pallet charging rack 602 and a dock 402 at which trailer 104 is parked.

Battery pallet racking system 600 may communicate with other battery pallet racking systems 600 at other warehouses 400, discussed in greater detail below.

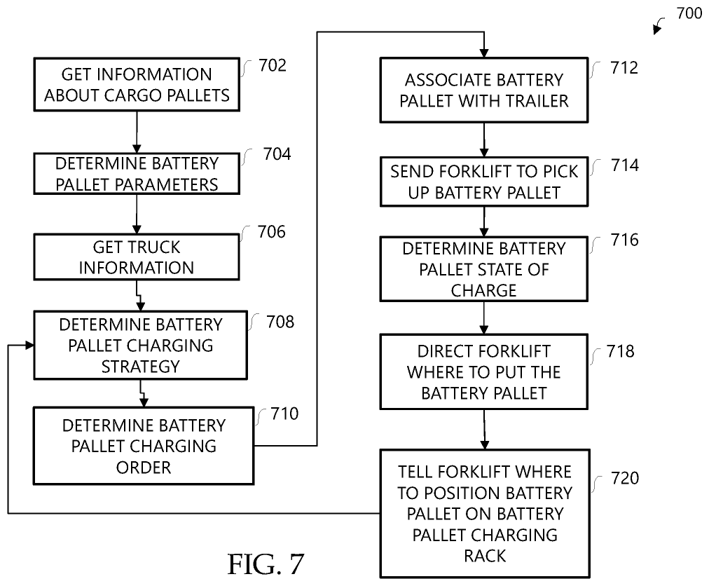

Referring to FIG. 7, a method is described for managing the charging of multiple battery pallets 110 for a warehouse environment.

At step 702, battery pallet racking system 600 may get information about a plurality of cargo pallets 105 originating from warehouse 400, passing through warehouse 400 to a final destination or ending at warehouse 400.

At step 704, battery pallet racking system 600 may determine, for each battery pallet 110 in battery pallet charging rack 602 in warehouse 400, a set of battery pallet parameters. In some embodiments, each battery pallet 110 periodically communicates its set of battery pallet parameters to battery pallet racking system 600 and battery pallet racking system 600 stores the set of battery pallet parameters. In some embodiments, battery pallet racking system 600 communicates with each battery pallet 110 as needed to get a set of battery pallet parameters.

At step 706, battery pallet racking system 600 may determine truck information for a plurality of trucks 102. In some embodiments, truck tracking system 612 communicates with a plurality of trucks 102 to get truck information for each truck 102. Truck information may include a vehicle weight, a route on which truck 102 is traveling, a state of charge (SOC) of a battery pallet 110 installed in a truck 102, a location of a battery pallet 110 installed on the truck and an estimated time for the truck 102 to reach a facility.

At step 708, battery pallet racking system 600 may determine, based on information about the plurality of cargo pallets 105, the information about the plurality of battery pallets 110 and the truck information, a minimum state of charge for a battery pallet 110 on the truck 102 and a number of battery pallets 110 needed to provide the minimum state of charge, charging parameters and a charging strategy for one or more battery pallets 110. In some situations, a charging strategy may comprise charging a subset of battery pallets 110 at a higher charging rate. For example, if all battery pallets 110 at warehouse 400 are at less than 50% SOC but a battery pallet 110 with at least 80% is needed to power a truck 102 on a route to its next destination, battery pallet racking system 600 may increase the charging rate of one battery pallet 110 to ensure the truck 102 associated with battery ballet 110 will have enough power to tow trailer 104 to the next destination on the route. Battery pallet racking system 600 may reduce the charging rate to other battery pallets 110 and/or configure battery pallet charging rack 602 to draw power from other battery pallets 110 to charge the battery pallet 110 without increasing the electric demand on warehouse 400 or a grid supplying electricity to warehouse 400. In some situations, multiple battery packs 110 may be necessary to provide a minimum state of charge for truck 102 to travel on a route. Embodiments may determine a number of battery pallets 110 with each battery pallet 110 having a minimum state of charge needed to provide truck 102 with a state of charge necessary to complete the route. Thus, it is not necessary for all battery pallets to be charged to 100% state of charge before installing them in truck 102. Instead of always charging every battery pallet 110 at a high charging rate to reach 100% state of charge or making truck 102 wait, embodiments select and manage the charging of battery pallets 110 to ensure trucks 102 have enough state of charge to complete routes.

At step 710, battery pallet racking system 600 may determine, based on information about the plurality of cargo pallets 105, the information about the plurality of battery pallets 110 and the truck information and determine an order in which a plurality of battery pallets 110 is to be charged. Referring to the example in step 708, a first battery pallet 110-1 may have been in battery pallet charging rack 602 for a day and is at 60% SOC and a second battery pallet 110-8 may have been in battery pallet charging rack 602 for four hours but is at 70% SOC. Even though first battery pallet 110-1 has been in battery pallet charging rack 602 a longer time, battery pallet racking system 600 may charge second battery pallet 110-8 at the higher charging rate because the higher charging rate will be applied for less time and second battery pallet 110-8 will be ready to be installed in the truck 102 or associated trailer 104.

At step 712, battery pallet racking system 600 may determine, based on information about the plurality of cargo pallets 105, the information about the plurality of battery pallets 110 and the truck information and select at least one battery pallet 110 for installing in truck 102 or trailer 104. In some embodiments, one or more specific battery pallets 110 may be selected based on the one or more specific battery pallets 110 state of charge (SoC) to provide the truck enough electrical power during travel over a predetermined route. In some embodiments, one or more specific battery pallets 110 may be selected based on the one or more battery pallets 110 state of charge (SoC) and determining that a generator operating on truck 102 will be unable to supply enough electric power along the predetermined route to charge the battery pallet 110 to a target SoC. Continuing with the examples in step 708 and 710, battery pallet racking system 600 may select second battery pallet 110-8 with the inbound truck 102 because the higher charging rate will be applied for less time and second battery pallet 110-8 will be ready to be installed in truck 102 or an associated trailer 104.

At step 714, when a truck-trailer combination 100 arrives at warehouse 400, trailer 104 may be parked at a dock 402 such that unloading of cargo pallets 105 and/or battery pallets 110 can begin. When a forklift 120 couples to forklift coupling features 504 on battery pallet 110, battery pallet 110 may supply electric power to forklift 120, allowing forklift 120 to continuously recharge or reduce the amount of time that forklift 120 is unavailable to move cargo pallets 105 and battery pallets 110.

Embodiments communicate with inbound trucks 102 to determine priority of battery pallets 110. At step 716, battery pallet racking system 600 may communicate with forklift 120 carrying battery pallet 110 to determine a SoC of the battery pallet 110.

At step 718, battery pallet racking system 600 may communicate with forklift 120 to direct forklift 120 to a dock 402 where a trailer 104 is parked.

At step 720, battery pallet racking system 600 may communicate with forklift 120 to provide a location in battery pallet charging rack 602 for positioning battery pallet 110.

Steps 708-720 may be repeated as needed to ensure all truck-trailer combinations 110 are able to load cargo pallets 105 and battery pallets 110 in trailers 104 such that all trucks 102 have power to reach the next destination and battery pallets 110 are charged using a system that reduces stress on each battery pallet 110.

Using the embodiments and processes described above, cargo pallets 105 may be loaded and unloaded efficiently relative to a plurality of trailers 104 over the course of a shipping day.

Using removable battery pallets 110 allows a truck 102 to require fewer battery pallets 109. In some embodiments, truck 102 is configured with battery pallet 110 having sufficient charge to travel a short distance for emergency situations or for moving around warehouse 400 when trailer 104 is not coupled to truck 102. Trucks 102 are not required to sit for hours while battery pallets 109 recharge. Instead, trucks 109 can park a trailer 104 at a dock and load up new battery pallets 110 to continue their duty day or can decouple from a first trailer 104 and couple to a second trailer 104 with a battery pallet 110 having a full SOC.

Each battery pallet 110 may be charged using a trickle charge when possible and any increased charging rate may be performed at a minimum rate to ensure a truck 102 can reach its next destination but with minimal stress on the battery pallet 110. Charging battery pallets 105 at lower charging rates may reduce the stress on warehouse 400 or the electric grid. A plurality of battery pallets 110 may also be used to supply power to warehouse 400. For example, if no truck-trailer combinations 100 are inbound and all battery pallets 110 are charged, embodiments may use power from battery pallets 110 to power warehouse 400 during peak electric times to reduce the strain on the grid or take advantage of less expensive times for charging battery pallets 110.

Using removable battery pallets 110 allows for easier maintenance and testing of each battery pallet 110. For example, while positioned in battery pallet charging rack 602, each battery pallet 110 may be subjected to various tests to determine an expected total battery life or discover any inconsistencies that could affect the total battery life. The tests may include temperature stress tests, power input or output tests, chemical testing, structural testing or inspections that may indicate the total battery life.

Embodiments may be utilized in other transportation systems. For example, embodiments have been explained as they relate to truck-tractor combinations 100. However, these embodiments may work equally as well with box-truck configurations in which the truck 102 and trailer 104 form one unit. Similarly, buses may utilize configurations that allow a bus to quickly replace a battery pallet 110 instead of spending hours to recharge. Similarly, a trailer 104 may be able to connect to a terminal tractor (not shown) used for shunting trailers around a yard.

Embodiments allow a truck 102 to be used independently of a trailer 104 and a trailer 104 to be used independently of a truck 102. If truck 102 is unusable due to an accident or requires maintenance, the battery power needed to move trailer 104 stays with trailer 104. Another truck 102 may travel to trailer 104 (including using battery pallet 110), connect to trailer 104 and immediately have enough battery power to pull trailer 104. Also, if trailer 104 is involved in an accident or requires maintenance, truck 102 can be disconnected and used to pull other trailers, and batter pallets 110 may be removed for use in other trailers 104.

What is claimed:

1. A battery pallet racking system, comprising:
a battery pallet charging rack for storing a plurality of battery pallets;
at least one charger selectively connected to the plurality of battery pallets; and
a management console storing a set of instructions that, when executed by a processor, cause the battery pallet racking system to:
communicate with each battery pallet of the plurality of battery pallets stored on the pallet charging rack to determine a state of charge for each battery pallet of the plurality of battery pallets;
communicate with a vehicle to determine a battery pallet with a state of charge below a minimum state of charge is installed in the vehicle; and
communicate with the at least one charger to selectively provide electric power to at least one battery pallet of the plurality of battery pallets stored on the battery pallet racking system to charge the at least one battery pallet to a target state of charge.

2. The battery pallet racking system of claim 1, wherein:
the battery pallet charging rack stores a set of battery pallets of the plurality of battery pallets in a row; and
the at least one charger comprises a charger coupled to a single charging connection corresponding to a first battery pallet of the set of battery pallets, wherein each battery pallet in the set of battery pallets comprises a first charging connection on a first side of the battery pallet for connecting to a battery pallet adjacent to the first side and a second charging connection on a second side of the battery pallet opposite the first side for connecting to a battery pallet adjacent to the second side, wherein the set of instructions, when executed by the processor, cause the battery pallet racking system to:
communicate with the charger to supply electric power to the first battery, wherein the set of battery pallets are charged in series to the target state of charge; and
select a battery pallet from the set of battery pallets for installing in the vehicle.

3. The battery pallet racking system of claim 1, wherein:
the at least one charger comprises a plurality of chargers, wherein each charger of the plurality of chargers is coupled to a charging connection of a battery pallet of the plurality of battery pallets, wherein the set of instructions, when executed by the processor, cause the battery pallet racking system to:
select a battery pallet of the plurality of battery pallets for charging to the target state of charge;
communicate with a charger connected to the selected battery pallet to charge the selected battery pallet to the target state of charge; and
communicate a signal to install the selected battery pallet with the target state of charge in the vehicle.

4. The battery pallet racking system of claim 1, wherein, to determine a battery pallet with a state of charge below a minimum state of charge is installed in a vehicle, the set of instructions, when executed by the processor, cause the battery pallet racking system to:
communicate with the vehicle to determine a route over which the vehicle will travel; and
calculate the minimum state of charge based on the route.

5. The battery pallet racking system of claim 1, wherein, to determine a battery pallet with a state of charge below a minimum state of charge is installed in a vehicle, the set of instructions, when executed by the processor, cause the battery pallet racking system to:
communicate with the vehicle to determine a vehicle weight; and
calculate the minimum state of charge based on the vehicle weight.

6. The battery pallet racking system of claim 1, wherein the set of instructions, when executed by the processor, cause the battery pallet racking system to:
determine a location on the vehicle of the battery pallet with a state of charge below the minimum state of charge;
communicate a signal to remove the battery pallet with a state of charge below the minimum state of charge from the location on the vehicle; and
communicate a signal to install the battery pallet with the target state of charge in the location on the vehicle.

7. The battery pallet racking system of claim 1, wherein the set of instructions, when executed by the processor, cause the battery pallet racking system to:
select a battery pallet with a state of charge closest to the target state of charge; and
communicate with a charger associated with the selected battery pallet to charge the selected battery pallet to the target state of charge.

8. A method of operating a battery pallet racking system in a facility, comprising:
storing a plurality of battery pallets;
determining a state of charge of each battery pallet of the plurality of battery pallets;
communicating with a vehicle to determine a state of charge of a battery pallet in the vehicle;
determining if the state of charge of the battery pallet in the vehicle is below a minimum state of charge;
selecting a battery pallet from the plurality of battery pallets for installing in the vehicle in response to determining that the state of charge of the battery pallet in the vehicle is below the minimum state of charge; and
communicating with a charger connected to the selected battery pallet to charge the selected battery pallet to a target state of charge.

9. The method of claim 8, comprising:
connecting a charger to a charging connection on a first side of a first battery pallet;
connecting a charging connection on a second side of the first battery pallet to a charging connection on a first side of a second battery pallet; and
communicating a signal to the charger to provide electric power to the first battery pallet, wherein the first battery pallet and the second battery pallet are charged in series, wherein selecting a battery pallet from the plurality of battery pallets for installing in the vehicle comprises selecting one of the first battery pallet or the second battery pallet.

10. The method of claim 8, comprising:
connecting a first charger to a charging connection on a first battery pallet;
connecting a second charger to a charging connection on a second battery pallet;
selecting a battery pallet of the plurality of battery pallets for charging to the target state of charge; and
communicating with the first charger to charge the first battery pallet to the target state of charge, wherein selecting a battery pallet from the plurality of battery pallets for installing in the vehicle comprises selecting the first battery pallet.

11. The method of claim 8, wherein determining a battery pallet with a state of charge below a minimum state of charge is installed in the vehicle comprises:
determining the vehicle is traveling on a route to the facility;
communicating with the vehicle to determine a present state of charge of the battery pallet installed on the vehicle;
calculating an end state of charge of the battery pallet installed on the vehicle based on the route; and
determining the end state of charge will be below the minimum state of charge.

12. The method of claim 11, wherein determining a battery pallet with a state of charge below a minimum state of charge is installed in the vehicle comprises:
communicating with the vehicle to determine a vehicle weight;
calculating an end state of charge of the battery pallet installed on the vehicle based on the vehicle weight; and
determining the end state of charge will be below the minimum state of charge.

13. The method of claim 8, further comprising:
determining a location on the vehicle of the battery pallet with a state of charge below the minimum state of charge;
communicating a signal to remove the battery pallet with a state of charge below the minimum state of charge from the location on the vehicle; and
communicating a signal to install the battery pallet with the target state of charge in the location on the vehicle.

14. The method of claim 8, wherein selecting a battery pallet from the plurality of battery pallets for installing in the vehicle comprises selecting a battery pallet with a state of charge closest to the target state of charge.

15. A facility, comprising:
a plurality of docks configured for parking a plurality of vehicles;
a battery pallet racking system comprising:
a battery pallet charging rack for storing a plurality of battery pallets;
at least one charger connected to the plurality of battery pallets; and
a management console storing a set of instructions that, when executed by a processor, cause the battery pallet racking system to:
communicate with each battery pallet of the plurality of battery pallets stored on the pallet charging rack to determine a state of charge for each battery pallet of the plurality of battery pallets;
communicate with a set of vehicles to determine a battery pallet with a state of charge below a minimum state of charge is installed in a vehicle of the set of vehicles;
communicate with the at least one charger to provide electric power to at least one battery pallet of the plurality of battery pallets stored on the battery pallet racking system to charge the at least one battery pallet to a target state of charge;
when the vehicle is parked at a dock at the facility:
communicate a signal to remove the battery pallet with the state of charge below the minimum state of charge from the vehicle; and
communicate a signal to install the battery pallet with the target state of charge into the vehicle.

16. The facility of claim 15, wherein:
the battery pallet charging rack stores a set of battery pallets of the plurality of battery pallets in a row; and
the at least one charger comprises a charger coupled to a single charging connection corresponding to a first battery pallet of the set of battery pallets, wherein each battery pallet in the set of battery pallets comprises a first charging connection on a first side of the battery pallet for connecting to a battery pallet adjacent to the first side and a second charging connection on a second side of the battery pallet opposite the first side for connecting to a battery pallet adjacent to the second side, wherein the set of instructions, when executed by the processor, cause the battery pallet racking system to:
communicate with the charger to supply electric power to the first battery, wherein the set of battery pallets are charged in series to the target state of charge; and
select a battery pallet from the set of battery pallets for installing in the vehicle.

17. The facility of claim 15, wherein the at least one charger comprises a plurality of chargers, wherein each charger of the plurality of chargers is coupled to a charging connection of a battery pallet of the set of battery pallets, wherein the set of instructions, when executed by the processor, cause the battery pallet racking system to:
select a battery pallet of the set of battery pallets for charging to the target state of charge;
communicate with a charger connected to the selected battery pallet to charge the selected battery pallet to the target state of charge; and
communicate a signal to install the selected battery pallet with the target state of charge in the vehicle.

18. The facility of claim 15, wherein, to determine a battery pallet with a state of charge below a minimum state of charge is installed in a vehicle, the set of instructions, when executed by the processor, cause the battery pallet racking system to:
communicate with the vehicle to determine a route over which the vehicle will travel; and
calculate the minimum state of charge based on the route.

19. The facility of claim 15, wherein, to determine a battery pallet with a state of charge below a minimum state of charge is installed in a vehicle, the set of instructions, when executed by the processor, cause the battery pallet racking system to:
communicate with the vehicle to determine a vehicle weight; and
calculate the minimum state of charge based on the vehicle weight.

20. The facility of claim 15, wherein, to communicate a signal to install the battery pallet with the target state of charge into the vehicle, the set of instructions, when executed by the processor, cause the battery pallet racking system to:
determine a location on the vehicle of the battery pallet with a state of charge below the minimum state of charge;
communicate a signal to remove the battery pallet with a state of charge below the minimum state of charge from the location on the vehicle; and
communicate a signal to install the battery pallet with the target state of charge in the location on the vehicle.
